(19) United States
(12) Patent Application Publication
(10) Pub. No.: US 2004/0218714 A1
(43) Pub. Date: Nov. 4, 2004

(54) Detection of explosive devices using X-ray backscatter radiation

(76) Inventor: Anthony A. Faust, Redcliff (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 10/428,073

(22) Filed: May 2, 2003

(51) Int. Cl. G01N 23/06

(52) U.S. Cl. 378/53

(57) ABSTRACT

Many parts of the world have anti personnel (AP) landmines (APLs) buried in their earth, which pose a great deal not only to fighting forces, but also to civilians. For any imaging system, detection of APLs is non trivial since APLs are typically relatively small, compact objects that are buried in a similarly dense medium, such as earth. Improved explosive device (IED) detection may prove to have more potential than detection of APLs in view of the increasing worldwide terrorist activity. A portable APL or IED detection apparatus is thus proposed that utilized a coded aperture mask as well as a radiation source in order to detect backscatter radiation from a target area for use in assessing whether the target area includes an APL or an IED. The coded aperture mask receives the backscatter radiation and forms an image on a detector array, this formed image is deconvolved with a response matrix of the coded aperture mask in order to form a visual representation of the target area.

### FIELD OF THE INVENTION

The invention relates to the area of detecting of explosive devices and more specifically in the area of using X-ray backscatter radiation for the detection thereof.

### BACKGROUND OF THE INVENTION

Through much of the last fifty years, the world's armies prepared for great tank battles across the plains of northern Germany. However, recent experiences in places such as Mogadishu, Grozny, and Sarajevo have made it increasingly apparent that modern battles are more likely to be fought in urban, built-up areas. As military forces and their war fighting capabilities become more technically advanced and more mobile, opponents are expected to increase their use of asymmetric deterrent means, such as Improvised Explosive Devices (IEDs), to attack or blunt military force advantages. Further, the growth of criminal and terrorist activities in the world has produced an ever-increasing threat to military and police Explosive Ordinance Disposal (EOD) teams, due mainly to increased IED sophistication. Also, many parts of the world have anti-personnel (AP) landmines (APLs) buried in their earth, which pose a great threat not only to fighting forces but also to civilians.

While most APLs do contain some metal, the quantities are often too small to allow for effective use of standard metal detection techniques. Instead, other properties of the APL such as material composition or structure thereof are typically exploited for purposes of detection. Although a number of techniques for the detection of APLs have been proposed over the years, penetrating radiation-based methods have often received the most promising reviews. Nuclear techniques for emitting penetrating radiation for use in the detection of explosives, studied for over 50 years, focus on the characteristic return radiation, or changes in the intensity of backscattered radiation, for potential target discrimination. In the literature, virtually every conceivable nuclear reaction has been examined, but after considering such factors as penetration, sensitivity, selectivity, size, weight, and power, only a few are thought to have the potential for APL detection.

To those of skill in the art it is known that in nuclear techniques suitable for APL detection, thermal neutron activation, neutron moderation and X-ray backscatter imaging techniques yield the most potential for fielding a workable system. Lateral Migration X- ray Tomography and Thermal Neutron Activation are the most promising techniques for use in vehicle mounted systems and are actively being investigated. For handheld applications, the size, weight and shielding issues further limit the useable nuclear reactions for use as efficient detection methods. Thus, lightweight systems typically feature weak sources and hence have limited APL detection capabilities.

Nuclear imaging has long been one of the few techniques available to aid in the identification of potentially dangerous objects in a non-intrusive manner. Unfortunately, these transmission based nuclear imaging techniques typically require that radiation source and detector components are placed at opposite sides of an object under interrogation, in the form of an APL or an IED. This limits the number of scenarios in which the detection technique is applicable in the field. A need exists for a detection apparatus that utilizes an energy source and respective detectors that are disposed on a same side of an object under interrogation.

For any imaging system, detection of APLs is non trivial since APLs are typically relatively small compact objects that are buried in a similarly dense medium, such as earth. Of course, detecting of APLs is considered preferred, since these objects are the most difficult to detect because of their similar density to the surrounding medium; however, IED detection may prove to have more potential in view of increasing worldwide terrorist activity.

A need therefore exists for a portable unexploded ordinance (IED or APL) detection system that is deployable into the field for detecting of unexploded ordinance.

It is therefore an object of this invention to provide a portable unexploded ordinance detection apparatus that utilizes an energy source and a respective detector disposed on a same side of an object under interrogation.

### SUMMARY OF THE INVENTION

In accordance with the invention there is provided an apparatus for illuminating a target area comprising: an isotopic radiation source for emitting radiation having a wavelength within a predetermined portion of the electromagnetic spectrum for illuminating the target area; a detector array having a plurality of detector elements that are responsive to the wavelength of the radiation, each of the detectors for providing a current in response to an intensity of the radiation incident thereon, the detector array only for receiving reflected radiation at the wavelength; and, a pixel coded mask (PCM) having a plurality of apertures transmissive to at least the wavelength of radiation for emission from the isotopic radiation source and in a predetermined spatial orientation forming the pixel coding therein, each aperture for passing backscatter radiation reflected from the target area at the wavelength, the mask for blocking propagation therethrough of radiation reflected from the target area at the wavelength other than through the apertures thereof, the PCM apertures spatially arranged with respect to the detector array for forming a plurality of pixel shadows on the detector array.

In accordance with the invention there is provided a method of illuminating a target area comprising the steps of: providing a PCM having a mask response matrix; providing a detector array comprising an array of detector elements; providing an isotopic radiation source; providing radiation from the isotopic radiation source for illuminating the target area with radiation; receiving backscatter radiation backscattered from the target area; propagating the backscatter radiation through apertures of the PCM, the apertures transmissive to at least a wavelength of the backscattered isotopic radiation; forming a plurality of pixel shadows on the detector array; generating current from each of the detector elements; and, generating data representative of the current from each the detector elements.

### BRIEF DESCRIPTION OF THE DRAWINGS

Exemplary embodiments of the invention will now be described in conjunction with the following drawings, in which:

FIG. 1 illustrates an electromagnetic (EM) radiation backscatter apparatus for use in detection of an APL;

FIG. 2a illustrates the return EM photon flux without the presence of an APL and the return EM photon flux with an APL present;

FIG. 2b illustrates the EM radiation photon flux for those photons that have interacted with the APL;

FIG. 2c illustrates the remaining photon flux for those photons that have not interacted with the APL;

FIG. 3a illustrates a conventional “pin hole camera” imaging system;

FIG. 3b illustrates a similar imaging system to that shown in FIG. 3a, however in this case the opaque mask is provided with ‘N’ apertures;

FIG. 4 illustrates a CAI apparatus in accordance with an embodiment of the invention, for use in CAI interrogation of a target object;

FIG. 5a illustrates a computer generated PCM design for a 61×61 MURA;

FIG. 5b illustrates the decoding matrix for use with the PCM shown in FIG;

FIG. 5c illustrates a delta function;

FIG. 6a illustrates a PCM when used with an off axis source;

FIG. 6b illustrates a larger detector array for use with the PCM with an off axis source;

FIG. 6c illustrates a mosaic of masks that are used to form the PCM;

FIG. 7 illustrates a shadow pattern ratio α, where the shadow ratio pattern is the ratio of the area of the shadow cast by a single PCM pixel to a number of detector elements in the detector array;

FIGS. 8a and 8c represent PCM and anti PCM patterns, with respective detector array response illustrated in FIGS. 8b and 8d;

FIG. 9a illustrates a generation of a PCM image generated and FIG. 9b illustrates generation of an anti PCM image;

FIG. 9c illustrates canceling of near field image artifacts by summing the two images of FIGS. 9a and 9b; and,

FIG. 9d illustrates enhancing of near field image artifacts by taking a difference of the two images of FIGS. 9a and 9b.

### DETAILED DESCRIPTION THE INVENTION

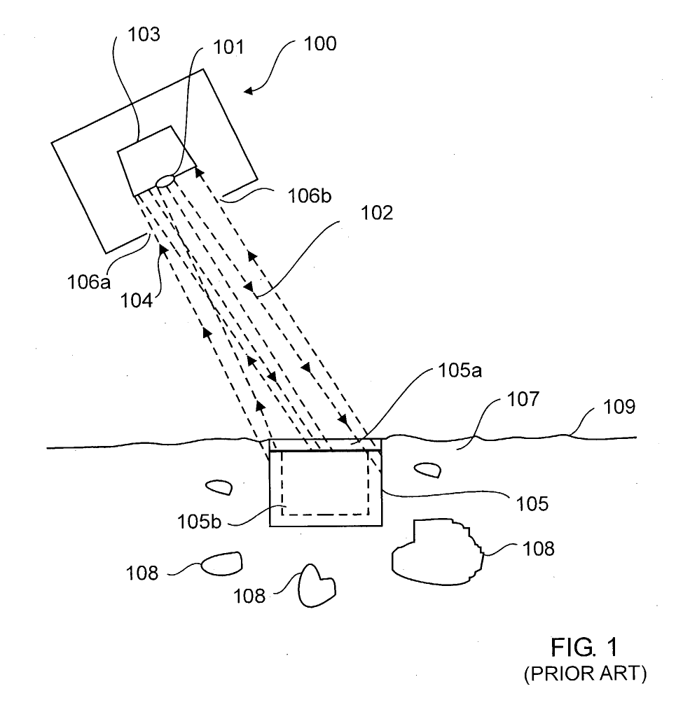

An alternative to transmission based nuclear methods for detection of APLs is an electromagnetic (EM) radiation backscatter technique, such as that illustrated in prior art FIG. 1. This technique involves irradiating an object under interrogation 105, or target object 105, with source EM radiation 102, in the form of either X-rays or Gamma rays, emitted from a radiation source 101 disposed in an instrument 100, and detecting a return EM radiation flux 104, using a detector 103, after the EM radiation flux reflects from the target object 105 disposed within a field of view (FOV) (aperture defined by 106a and 106b), of the instrument 100. Characterization of the EM spectrum of the returning EM radiation 104 through energy density, spatial density, or temporal distributions, is then used to distinguish material distributions in the instrument's 100 field of view (FOV). Variations in the properties of a soil matrix 107, such as those caused by the presence of an unexploded ordinance 105 change the absorption and scattering probabilities of the reflected EM radiation and thus affect the return EM radiation flux 104. Characterizing of this return EM radiation flux 104 thus allows for determination of whether an unexploded ordinance 105 is present, or not, within the soil matrix 107.

In discussing EM radiation interactions, relevant quantities are the EM radiation energy, Eγ, density ρ of the target 105 and an average atomic number Z of the target 105. For EM radiation energies that are useable in a hand held instrument, Eγ is preferably less than 2 MeV through the use of an EM radiation source 101 in the form of an isotopic source or electronic generator. Primary interactions contributing to the EM radiation backscattering are the photoelectric effect and Compton scattering. The Compton cross section, per electron, σₜ, is expanded in terms of the incident EM radiation energy E and the mass of the electron me, where E/me<σₜ, in the following equation for σₜ:

$${σ}_{t} = \frac{8 π α}{3 {m}_{e}} ( 1 - 2 \frac{E}{{m}_{e}} + 5.2 \frac{{E}^{2}}{{m}_{e}^{2}} - 1.33 \frac{{E}^{3}}{{m}_{e}^{3}} + 32.7 \frac{{E}^{4}}{{m}_{e}^{4}} + … ) , \qquad [ 1 ]$$

where α is an electromagnetic coupling constant.

For a material with density ρ, atomic number Z, mass A, and Avogadro's number N_{A}, a macroscopic attenuation length is written as:

$$μ = ρ {N}_{A} \frac{Z}{A} {σ}_{t} . \qquad [ 2 ]$$

For low atomic mass materials, except Hydrogen where 2Z≈A, and substituting Eqn.( 1) into Eqn.( 2), it is found that:

$$μ α ρ ( 1 - 2 \frac{E}{{m}_{e}} + … ) . \qquad [ 3 ]$$

Eqn.( 3) shows how Compton scattering is used to determine density variations in a target area, which is the basis of Compton Backscatter Tomography (CBT) techniques.

Fortunately, using this technique for detection of APLs is difficult since the bulk densities of the composition of materials in the soil matrix 107 and those used in manufacturing of an APL 105, for example, are quite similar, where ρ_{APL}≈ρₛₒᵢₗ. However, this simply accounts for only single photon EM radiation scattering events. Realistically, multiple photon EM radiation scattering events make a significant contribution to the photon EM radiation backscatter flux. This additional information, in conjunction with the photoelectric effect is potentially useable to further enhance detection capabilities of this technique. To those of skill in the art, it is known that APLs 105 typically encompass regularly shaped low-density air voids 105a. These air voids 105a typically contribute to APL detection probability when using the aforementioned imaging technique. Unfortunately, IEDs tend to be constructed of materials with widely varying densities, such as explosives, metals, and air voids, for example; thus detection of IEDs using the aforementioned technique is difficult. Of course, in using multiple EM radiation photon scattering events detection of IEDs is mitigated and not definite.

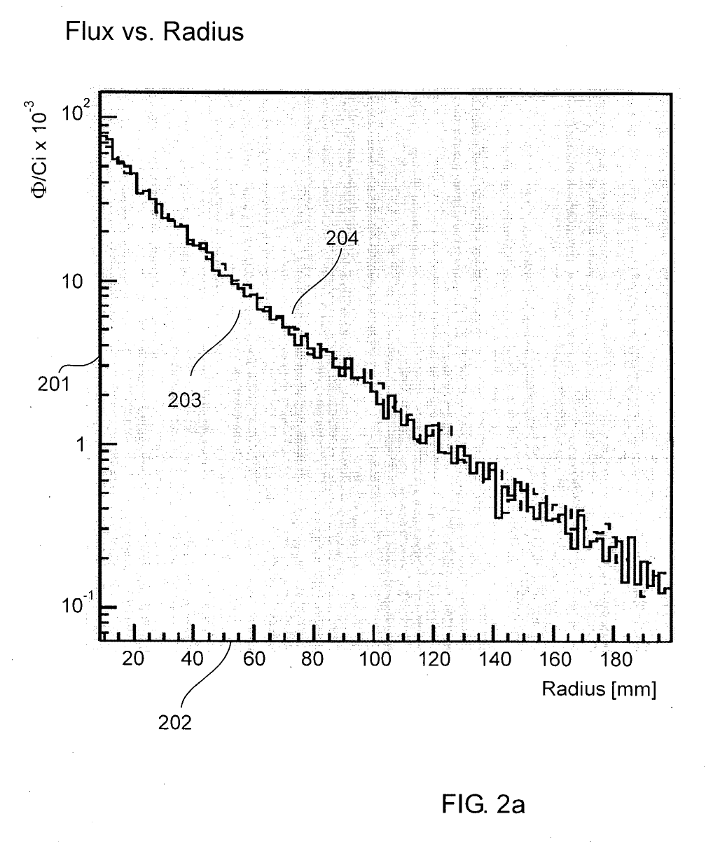

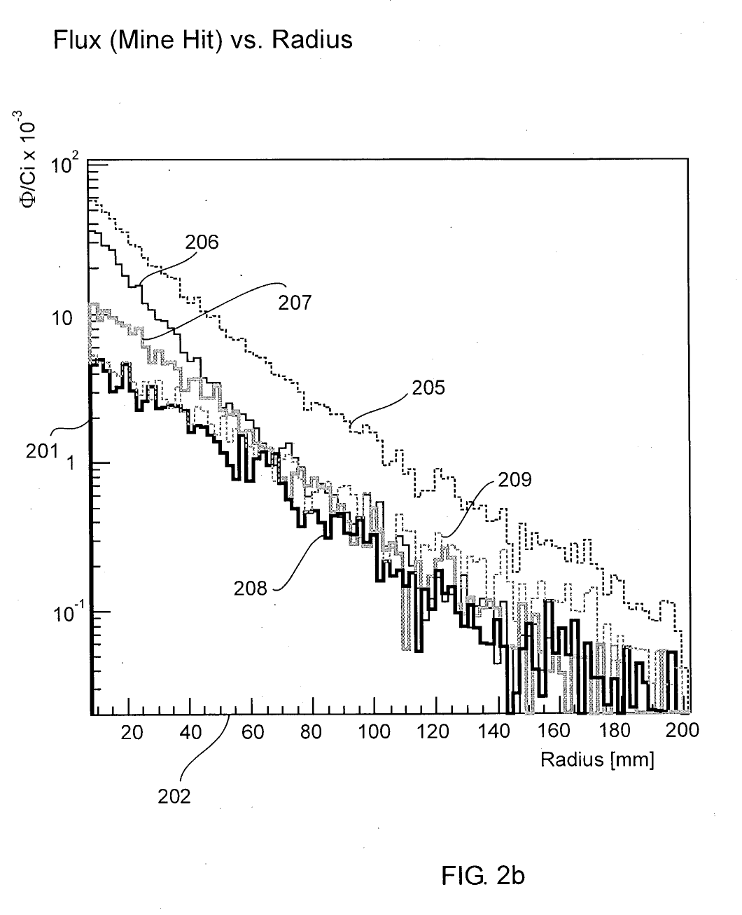

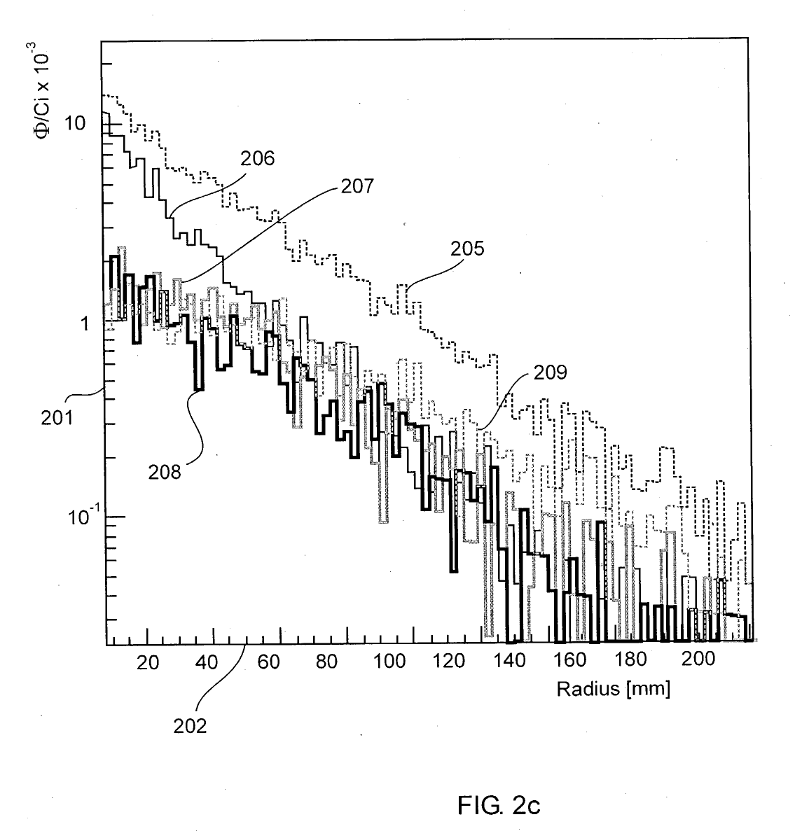

For the graphs illustrated in FIG. 2, a simulated X-ray back scatter field is shown for 122 keV photons isotopically generated at a height of 2 cm above a ground matrix and collimated into a 10° cone directed downwards. The ground matrix for this simulation is sand with a density ρ−1.54 g/cm³. A graph correlating the return flux φ=photons/s/cm² scaled per mCi source activity 201 vs. radial distance 202 from the electron source is shown in the figures of FIG. 2. For the purposes of this simulation, the target is in the form of an APL and has a shape of a circular cylinder with a diameter of 3 cm and a height of 3 cm buried flush with the ground surface (as shown in FIG. 1). The landmine in this case contains TNT 105b with a density ρ=1.61 g/cm³, and a thin 3 mm layer of air 105a just under the landmine surface. This air void 105a found in most APLs, as those of skill in the art are aware, has been shown to aid in various APL imaging techniques.

FIG. 2a illustrates the return EM photon flux without the presence of an APL, solid line 203, and the return EM photon flux with an APL present, dashed line 204. In the simulation, the backscatter efficiency recorded over an annular detector plane 202 with a radius from 1 to 22 cm and at a height of 2 cm above the ground 107 was determined as 26.3% in the absence of an APL. With an APL present the EM photon backscatter efficiency was determined as 27.2%, with 72.7% of those EM photons having interacted with a volume of the APL 105.

FIGS. 2b and 2c illustrate the return EM radiation photon flux in the presence of an APL, where FIG. 2b illustrates the EM radiation photon flux for those photons that have interacted with the APL, and FIG. 2c illustrates the remaining photon flux for those photons that have not interacted with the APL. In both FIG. 2b and FIG. 2c, the overall photon flux 205 is recorded. Furthermore, the overall photon flux 205 is resolved into Compton interaction events, with 1 interaction 206, 2 interactions 207, 3 interactions 208 and >3 interactions 209. As is expected, the single scatter event 206 dominates in the hard backscatter region directly behind the interaction point—closer to the radial center. Multi scatter events tend to diffuse out and dominate in the outer radial region, further from the radial center.

A number of non-imaging X-ray backscatter techniques have been attempted for use in detection of APLs, but these failed to provide a fieldable system, due in part to their sensitivity to background clutter objects 108 disposed in the ground proximate the APL and variations in the ground surface 109. Thus, an imaging technique is needed that reduces a false acceptance rate by providing an operator with spatial information of sufficient fidelity to differentiate between clutter objects 108 and target objects of interest 105, such as APLs.

A point detector based on X-ray albedo typically utilizes a comparison to a reference albedo, which is strongly correlated to detector height above the target object. However, an imaging system using X-ray albedo solves this problem by simultaneously sampling a larger FOV, thus providing direct albedo comparison between pixels. Fortunately, advances in X-ray detection are continually being made, driven by requirements in medical applications, with detectors that are faster, cheaper and lighter than those available a decade ago. Thus, with the advances in X-ray detection, potential advances in hand-held imaging systems are possible.

For imaging techniques that scan a focused beam over a target area, the single and multiple scatter components, as shown in the figures of FIG. 2, complementary information is shown, and both techniques are useable with proper collimation. However, these techniques do have their drawbacks since collimation equipment has not yet been available for use in hand-held system.

Another approach is to avoid tight collimation of emitted photon radiation and instead to immerse the whole FOV of the instrument in source photons. Unfortunately, in this case there is no prior knowledge of the incident photon paths, which limits the possibilities in differentiating between single and multiply scattered photons. Thus, contributions to the formed image from the latter typically lead to blurring and therefore limit the detection capabilities of APLs. However, such a technique that avoids collimation of emitted photon radiation is potentially useable for IED detection. Avoiding collimation of emitted photon radiation is a technique that forms the basis for Coded Aperture Imaging (CAI) and is hereinbelow presented in accordance with embodiments of the invention.

Astronomy groups for observation of gamma rays from space have used CAI. Recent work in the area of medical nuclear imaging has allowed for the development of this technique for backscatter applications. Recent advances that have made backscatter imaging feasible are depth reconstruction and near-field artifact reduction. For the photon energies of interest that are useable for CAI, traditional imaging techniques are not possible due to limitations brought about by the physics of the interaction of the photons with matter. Specifically, due to the wavelength of the EM radiation, and thus its higher energy, it is not possible to focus the EM radiation using conventional lens imaging techniques.

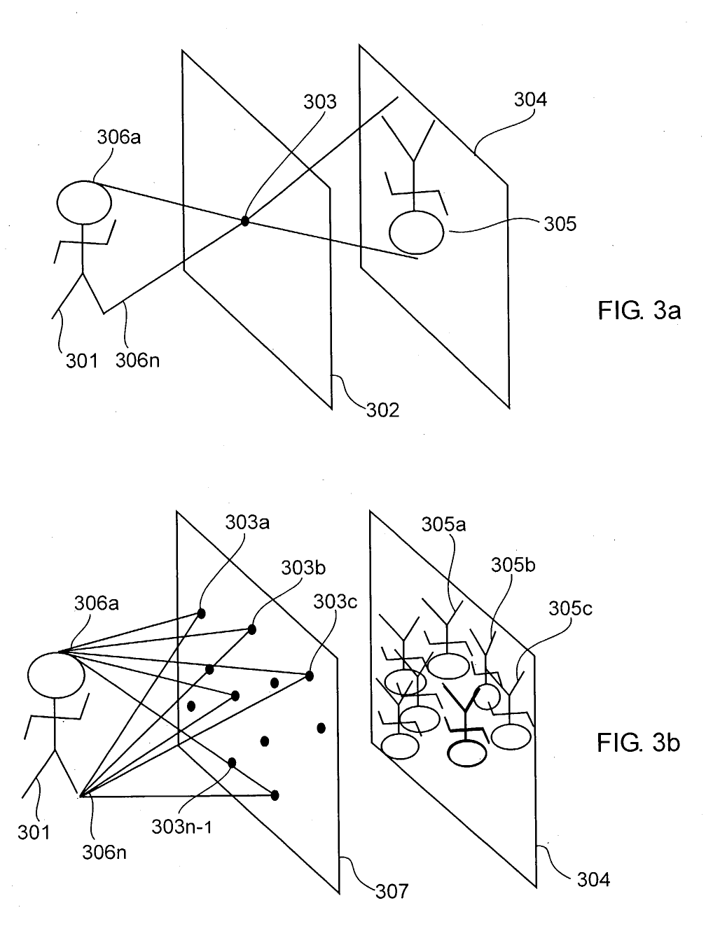

Fortunately, an alternative class of imaging techniques that employ straight line ray optics are available for imaging of this higher energy EM radiation. FIG. 3a illustrates a conventional “pin hole camera” imaging system. An opaque mask 302, having a single aperture 303 in the form of a pinhole, is disposed between a source object 301 and a detector array 304. At other than the aperture 303, the mask is opaque to EM radiation of the rays 306a through 306n. The EM radiation in the system is provided by an EM radiating source (not shown) that radiates EM radiation within a predetermined portion of the EM spectrum. This EM radiation reflects from the source object 301, thus forming rays 306a through 306n that propagate using straight line ray optics through the aperture 303 and are imaged 305 onto the detector array 304. While this design, illustrated in FIG. 3a, directly generates an image of the source object 301 with no additional processing, its imaging efficiency suffers from a limited ray acceptance, since the aperture 303 is quite small. Thus, a large amount of optical energy associated with the reflected EM radiation is lost and not received by the detector array 304.

FIG. 3b illustrates a similar imaging system to that shown in FIG. 3a; however, in this case the opaque mask 307 is provided with ‘N’ apertures 303a through 303n, where each of these apertures receives a plurality of rays 306a through 306n reflected from the source object 301. The rays propagate through the ‘N’ apertures 303a through 303n and are subsequently imaged on the detector array, forming ‘N’ images 305a through 305n. The spatial position of each of the ‘N’ images that form other than a shadow on the detector array is dependent upon a position of the respective aperture (303a through 303n) through which the rays propagated from the source object 301 in order to form the respective image.

Imaging techniques for use in CAI utilize a similar mask to that shown in FIG. 3b, where a precisely designed “collimator,” in the form of an opaque mask comprised of either transparent or opaque pixels to the source radiation, is placed between the photon source and a large-area planar detector array. As the pixel position on the mask design is known, the photon source distribution is then reconstructed by convolving the detector response with a shadow pattern cast by the mask on the detector array. As is illustrated in FIG. 3b, a different shadow pattern for each aperture is generated for reflected EM radiation reflected from the source object and propagating through the FOV of each aperture. Each shadow pattern cast by each aperture is shifted based on the relative position of the EM radiation reflection point to that of the aperture. Determining the strength of every possible shadow pattern on the detector array is useable in reconstruction of the photon source distribution.

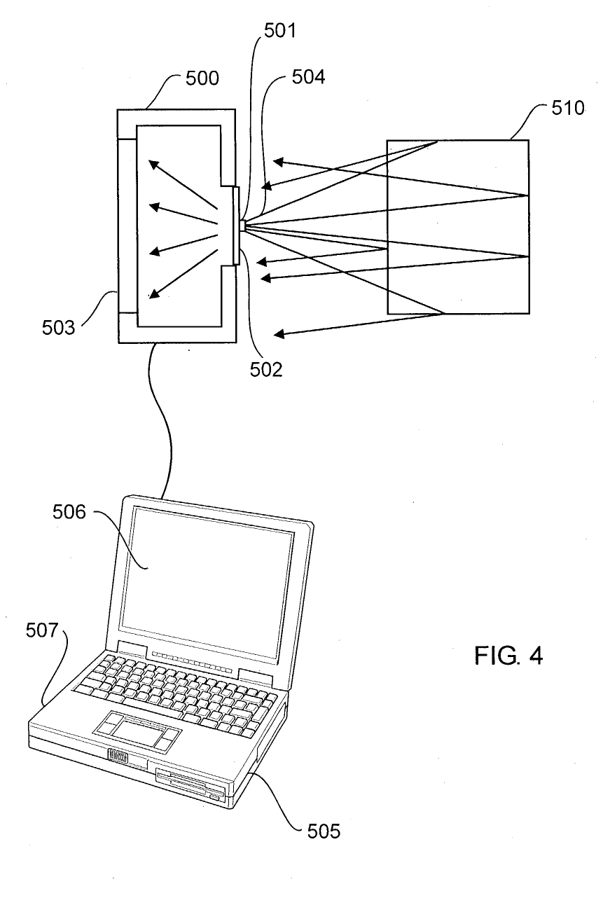

FIG. 4 illustrates a CAI apparatus 500 in accordance with an embodiment of the invention, for use in CAI interrogation of a target object 510. An isotopic radiation source 501 is disposed at a geometric center of a pixel coded mask (PCM) 502 for radiating energy 504 towards the target object 510. A receptacle is preferably disposed on the PCM 502 for housing of the isotopic radiation source for permitting radiation to be emitted from the isotopic radiation source at a predetermined half angle of preferably between 10 and 45 degrees. A portion of the radiating energy emitted from the isotopic radiation source reflects from the target object 510 and propagates through the PCM 502 and casts a shadow on a detector array 503 disposed on an opposing surface of the CAI apparatus 500 as the PCM 502. A housing for the CAI apparatus provides shielding to the sensitive detector array 503 surface, where the shielding ensures that only the radiating energy coded by the PCM 502 reaches the detector array 503. Detector elements forming the detector array each generate a response signal in response to an intensity of the radiation incident thereon. The isotopic source 501, disposed on the face of the PCM 502, and is preferably apertured in a predetermined manner to provide only a required FOV for the CAI apparatus 500. The CAI apparatus 500 further comprises a processing unit 507 and a display unit 506 as well as a processor 505 for receiving of the response signal from each of the detector elements.

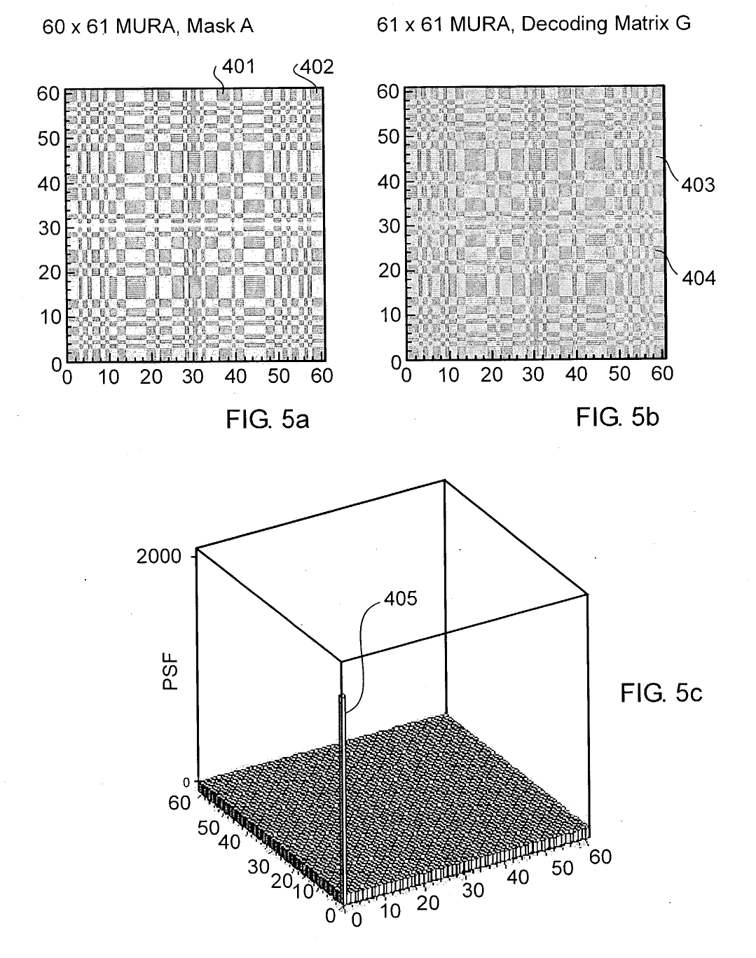

Optionally, the CAI apparatus illustrated in FIG. 5 utilizes a 21×21 pixel coded mask, in a 2×2 mosaic (discussed hereinbelow), for use in casting the pixel shadows on the detector.

Therefore, in using of this aforementioned apparatus 500, a direct image of the target 510 is not directly reconstructed on the detector array 503, as is the case for standard optical imaging. The image displayed on the detector array is a composition of images resulting from pixel shadows on the detector array from each of the pixels in the PCM. Thus, to derive an image resembling the target object 504 and to display this image on the display unit, a computationally intensive convolution process is carried out by the processor 505. In prior art systems, computationally intensive convolution was a limiting factor, however, modern computational power has made this two stage process—detecting and convolution—a viable option for real-time image processing for target object reconstruction.

Using the detector array 503 naturally leads to a 2D representation of the data derived from the received convolved target image, D, where Dij represents the intensity value recorded in the (i,j)^{th} detector element of the detector array 503. The PCM 501 is represented as matrix A, with pixel elements Aij such that Aij=1 if the (i,j)^{th} mask pixel is transparent and Aij=0 if the pixel is opaque. The FOV of the detector is partitioned—discretized—into discrete segments, where the source distribution is represented as a matrix, S, with Sij describing a number of EM radiation photons that are reflected from the target area encompassing the target object and emanating from the (i,j)^{th} cell in the discretized FOV. In using the aforementioned definitions, D is a matrix of the detector response to the source distribution S—EM radiating photons reflecting from the target area—and propagating through the aperture matrix A, as follows:

D=S*A+B,

where * is a periodic correlation and B accounts for noise and other background contributions. If a matrix G is found, such that Λ*G=δ, where δ is the Kronecker delta function (FIG. 5c), such that an approximate source Ŝ distribution is found as follows:

$$\hat{S} = D * G \\ = ( S * A ) * G + B * G \\ = S + B * G \qquad [ 5 ]$$

Given the measured detector response D and a known decoding matrix G, determined by the mathematical representation of the PCM 502, Eqn. 5 is used to derive an approximation of the source distribution S in the detector's FOV.

A specific family of aperture designs, known as Modified Uniform Redundant Arrays (MURA), has been found to have particularly useful imaging properties for use as the PCM 502. MURAs are represented by square matrices having dimension that are derived from a prime number that satisfy the following: N=4n+1, or N=4n+3, for n being a positive integer (n∈Z⁺). The pattern forming the PCM 502 is defined as follows:

$${A}_{i j} = \{ \begin{matrix}0 & if i = 0 \\ 1 & if j = 0 , i \neq 0 \\ 1 & if c ( i ) c ( j ) = 1 \\ 0 & otherwise\end{matrix} ,$$

where c is a quadratic residue array,

$$c ( i ) = \{ \begin{matrix}1 & if ∃ x ∈ {Z}^{+} , 1 \leq x < ρ , ∋ \text{:} i = {mod}_{p} {x}^{2} \\ - 1 & otherwise\end{matrix}$$

The decoding function G, for forming of a decoding matrix, is defined as:

$${G}_{i j} = \{ \begin{matrix}1 & if i ⊕ j = 0 \\ 1 & if {A}_{ij} = 1 , i ⊕ j \neq 0 \\ 0 & if {A}_{ij} = 0 , i ⊕ j \neq 0\end{matrix}$$

, where \mathring{+} is a periodic summation.

In determining the correlation from Eqn. 5, the correlation is expanded as:

$${\hat{S}}_{i j} = {\sum }_{k} {\sum }_{l} {D}_{i j} {G}_{i ⊕ k , j ⊕ l}$$

The number of calculations required to calculate the aforementioned equation grows in the order of n³, thus the processing time is quite slow for any significant PCM dimension. Employing Convolution Theorem Fast Fourier Transform routines reduces the calculations required to the order of n²logn.

FIG. 5a illustrates a computer generated PCM design for a 61×61 MURA. The white areas 401 correspond to transparent pixels and the gray areas 402 to opaque ones. In this case, the PCM is comprised of 3721 pixels an array of 61×61 pixels, of which 1860 are transparent, yielding a transmission efficiency of 49.99%, which approaches the theoretical maximum of 50%.

FIG. 5b illustrates the decoding matrix for use with the PCM shown in FIG. 5a. Dark gray 404 areas correspond to a +1 entry in the decoding matrix, and the light gray 403 areas correspond to a −1 entry in the decoding matrix. FIG. 5c illustrates a system Point Spread Function (PSF), determined by A*G, which produces a delta function 405 as required.

For IED and de-mining applications, speed of interrogation the target area to determine whether it is an IED, APL, or not, is of importance. The faster the speed of interrogation, the more area that is searchable for IEDs and APLs. Preferably, as large a detecting array 503 area as is practicable is utilized, since the larger the area of the detector array 503, the larger the FOV of the CAI apparatus 500. However, the FOV of the CAI apparatus is usually constrained by cost and logistics.

For a given detector array 503 size, the most efficient system utilizes a same sized detector area 503 as the area of the shadow cast by the PCM 502 on the detector array 503. In using an isotopic source 501 that is disposed in a geometric center of the PCM 502, this ensures that the shadow pattern cast on the detector array 503 is fully encoded by the detector array 503.

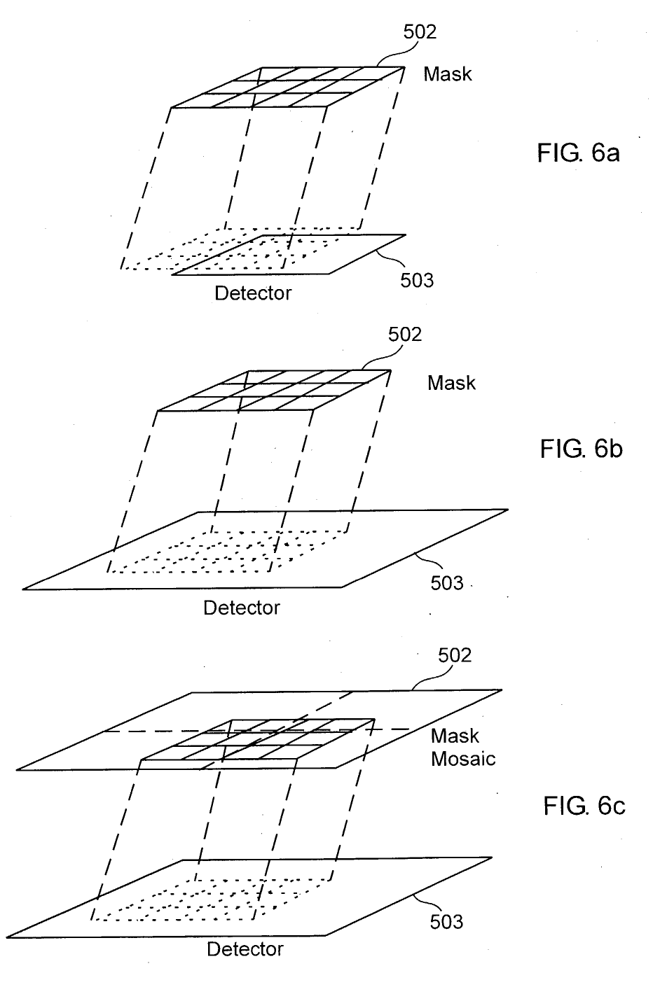

For any off-axis source 501, such as that utilized with the PCM shown in FIG. 6a, the shadow partially misses the detector array 503. This results in a partially encoded image, which is of course not preferable, since a portion of the detector array 503 is not utilized.

Of course, increasing of the detector area is an option, such as that illustrated in FIG. 6b, but with a same sized PCM 502 and thus limited FOV. This also results in an inefficient use of the detector area. In this case, only a portion of the detector array 503 area is used for encoding of the shadow and the rest of the area is unused.

Fortunately, by exploiting a cyclic nature of the mask pattern used to form the PCM, a fully encoded FOV is increased by enlarging the mask by mosaicing copies of the basic mask pattern to form the PCM, as illustrated in FIG. 6c. This mosaicing forms a mosaiced PCM (MPCM). An example of a PCM in the form of a MPCM is shown in FIG. 5a.

To those of skill in the art of CAI, it is known that the observational gamma astronomy community has used technique of CAI for a number of years. But, these techniques have exploited the use of CAI for far field applications. In far field applications the gamma particles are essentially parallel once incident on the detector array. In the near field case, such as in X-ray backscatter, the far field approximation is no longer valid and CAI is of limited practical value due to image artifacts.

For a given PCM, A, (such as FIG. 4a) and a decoding matrix, G, (such as FIG. 4b) pair (A,G), such that A*G=δ (FIG. 5c), the pair (1-A,-G) also offers the same imaging properties, where 1-A is termed an anti mask. The anti mask is constructed by replacing transparent pixels by opaque pixels, and vice versa. It is then observed that a number of image artifacts destructively interfere in the summation of mask and anti-mask images, but that the object images constructively interfere. The opposite is also true, where the mask and anti-mask images are subtracted, the object images cancel and the image artifacts are enhanced.

Advantageously, unlike any other field portable same sided imaging apparatus, backscatter CAI systems provide the ability to reconstruct images in depth, as is known to those of skill in the art. This important feature has the potential to change the way in which imaging systems are deployed for use in IED and APL detection roles.

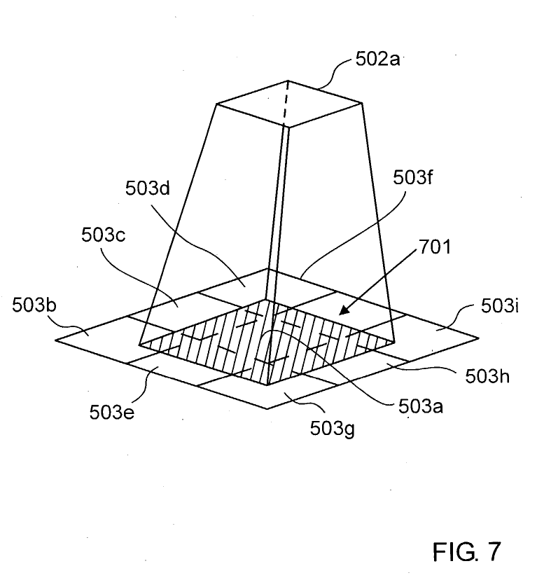

For far-field objects, such as stellar observation, the pixel shadow (701, FIG. 7) cast by a single mask pixel is often designed to cover an integer number of detector elements, with the complete mask casting a mask shadow that is preferably over all the detector elements. In the near-field case, distant focal planes behave in much the same manner as in the far-field case. However, near focal planes cast a larger mask shadow on the detector array. Preferably the size of the detector area is such that this larger mask shadow image area is included, and then images are reconstructable for various depths by varying the detector array area that is used in image analysis. Thus, the full area of the detector array is used for the near field case and a smaller area for progressively further focal lengths as the far field is approached. Of course, as the focal length is varied a situation is encountered where a ratio of mask pixel shadow 701 area to detector element area 503a, α, is a non-integer value, as illustrated in FIG. 7. FIG. 7 illustrates a shadow pattern ratio α, where the shadow ratio pattern is the ratio of the area of the shadow 701 cast by a single PCM pixel 502a to a number of detector elements in the detector array 503. Detector array element 503a is fully shadowed by the shadow cast from PCM pixel 502a, but proximate and adjacent detector array elements (503b-503i) are only partially shadowed.

In order to address this issue, a virtual grid is applied to the detector elements during a processing operation thereof. This virtual grid defines a primary mask shadow for a particular focal length being reconstructed by the CAI apparatus 500. For each mask pixel shadow in this virtual grid, the corresponding detector elements are summed and weighted by the fractional area shadowing each detector element (503a-503b for example).

There are a large number of variables that are utilized for designing of the CAI apparatus. Preferably the large number of variable including: PCM mask size and order, mask pixel size and depth, mask to object distance, mask to detector distance, detector element size, α, FOV and geometric resolution, that are correlated using computer simulation in order to design and develop a portable CAI apparatus. A simulation of the CAI apparatus in use is described below.

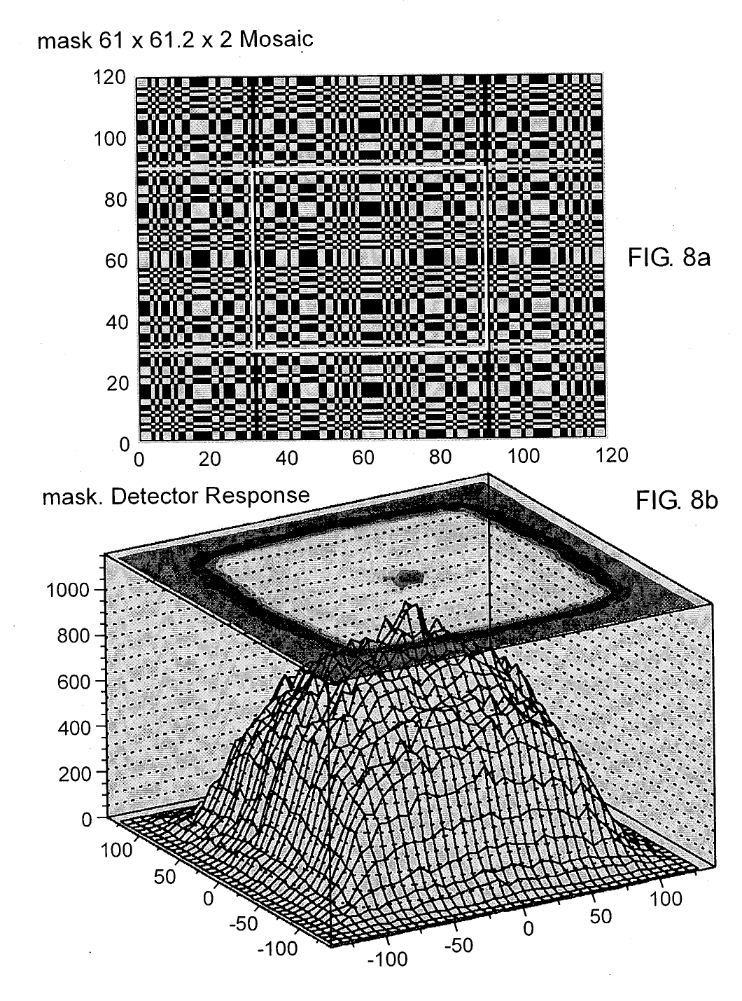

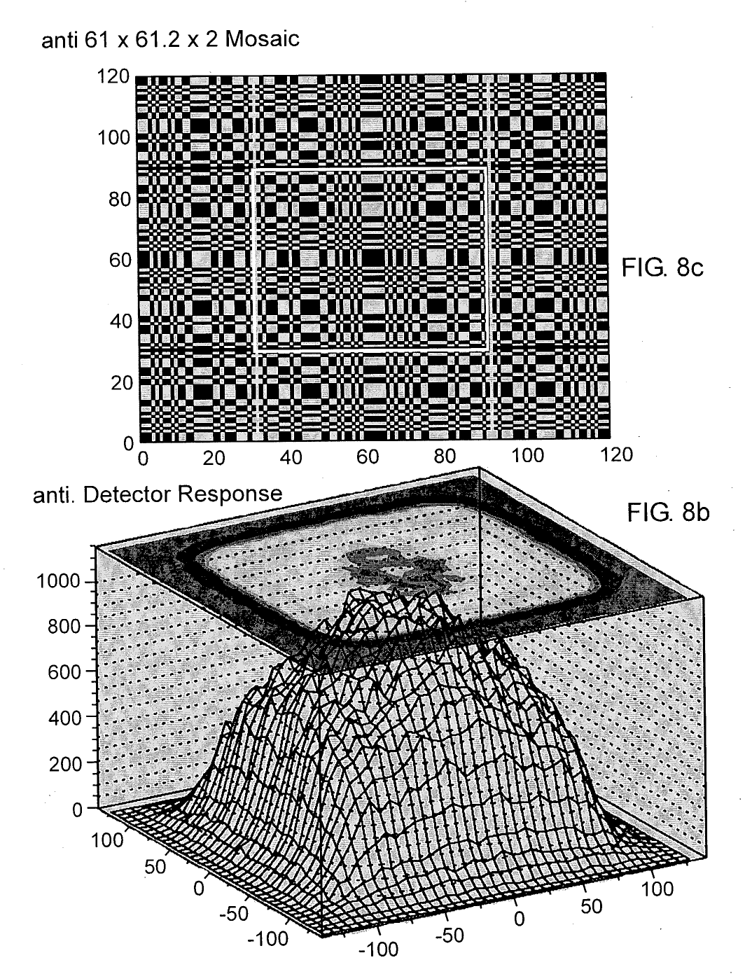

Referring to FIG. 5, the target 510 is an aluminum box having dimensions of 10 cm³, with 3 mm thick walls, with a 4 cm³ cube of RDX (C₃H₆N₆O₆)—a common explosive—having a density of 1.8 g/cm³, disposed at its center. The PCM 502 of the CAI apparatus 500 in this example utilizes a PCM that is comprised of a 61×61 pixel MURA mask, in a 2×2 mosaic (FIG. 8a), constructed out of 1 mm thick lead, with each pixel being a 1 mm² square in area. The detector array is 80 mm×80 mm in size and is comprised of 3721 detector elements, with each element being 1.3 mm² square. The detector array is preferably disposed 75mm from the PCM. This arrangement, for α=1, the magnification of the system is 1.31 and the focal plane is 240 mm in front of the PCM. At this focal depth, the FOV is 255 mm×255 mm, which results in an image of each pixel on the detector array having a square size 4 mm².

For use with the target object 510 shown in FIG. 5, the CAI apparatus is placed such that a distance between the PCM 502 and the closest face of the target is 10 cm, which is equivalent to a distance of 13 cm between the PCM and the RDX explosive. In this scenario, α=1.21 and the magnification is 1.58. This results in an FOV of 167 mm×167 mm, which results in an image of each pixel—pixel shadow—on the detector array having a square size of 2.7 mm².

FIGS. 8a and 8c represent PCM and anti PCM patterns, with respective detector array response illustrated in FIGS. 8b and 8d. These computer generated figures are a result of simulation using a 20 mCi isotopic EM radiation emitter source collimated into a cone with a half-angle 30 degrees, with an Eγ=122 keV. For this simulation, the detector elements in the detector array are assumed to be 100% efficient. Thus, only statistical variations are present in images shown in FIGS. 8b and 8d. Of course, Eγ is not limited to 122 keV, an upper limit of 1022 keV is also useable.

The relative detector response illustrated encodes all depth information. Specific depths are reconstructed by evaluating select regions of the detector array corresponding to known magnification values. In this manner, the EM radiation source—an X-ray scatter in this case—is reconstructed as out of focus images in all but a single depth, which contributes to substantial noise in a 3D reconstruction. Thus, isolating each reconstructed single depth image is preferably implemented in order to reduce noise for 3D reconstruction.

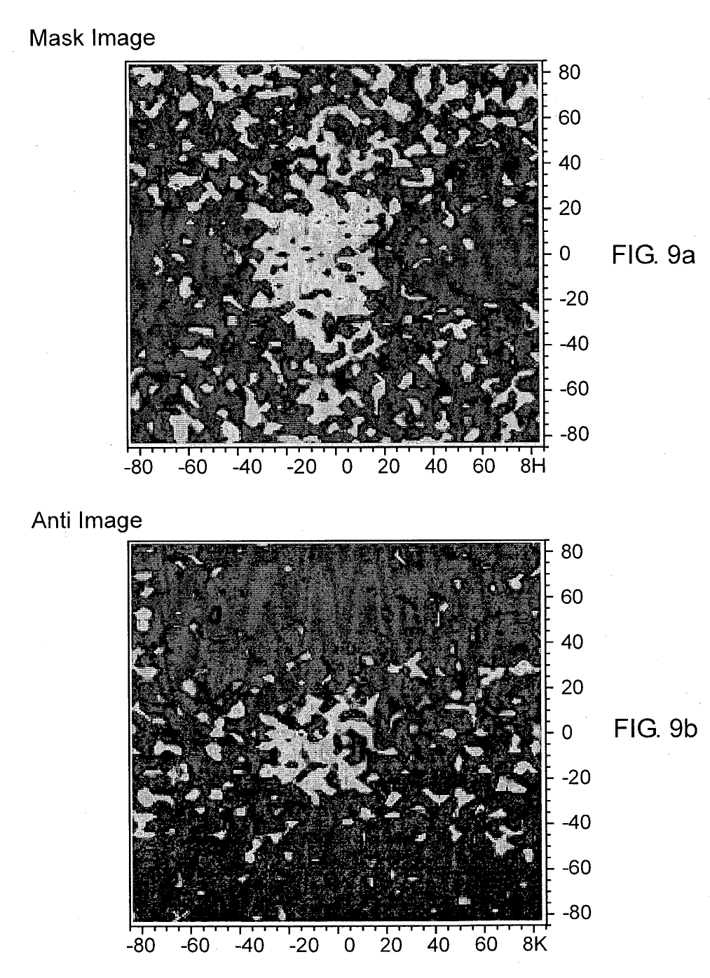

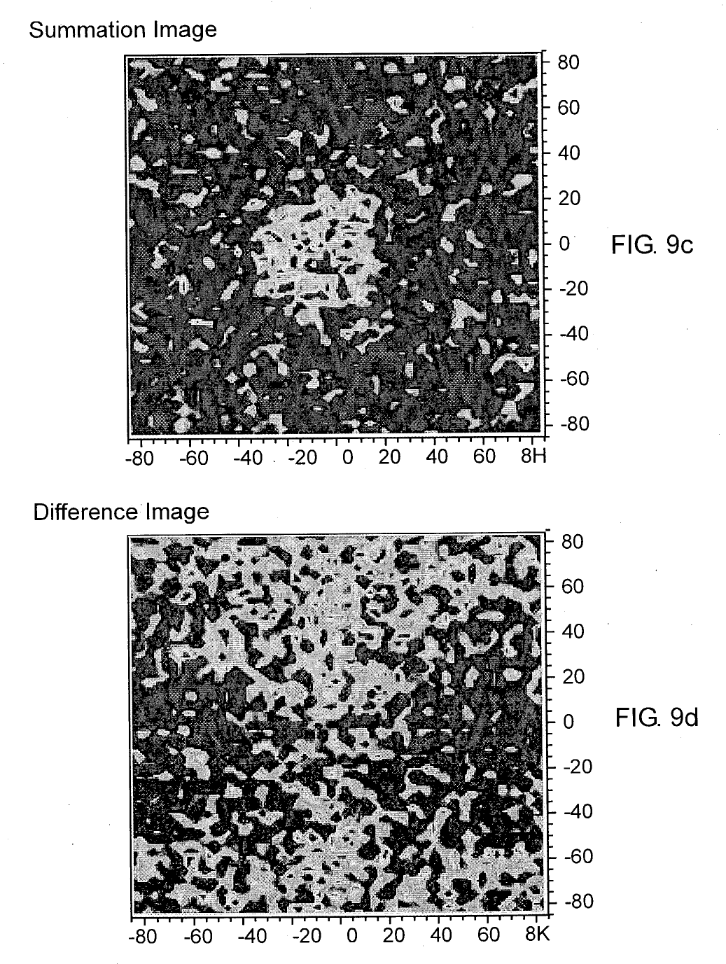

FIG. 9 illustrates computer-generated images for an image depth of 130 mm. Referring to FIG. 9a, a PCM image is generated, and in FIG. 9b, an anti PCM is generated. Near field image artifacts are cancelled by summing the two images, as shown in FIG. 9c, and enhanced through their difference as shown in FIG. 9d. From these computer generated images, the image quality of the target area is improved through the summation procedure. Preferably, through the summation procedure the quality of the images is improved. Successful simulation of backscatter imaging has demonstrated its use in IED detection.

Unlike systems used for the detection of APLs, systems used for detection of IEDs are not readily available. Current imaging methods typically require access to two sides of an object under interrogation and thus are cumbersome for use in the field. Preferably, the CAI apparatus for use in the field is in the form of an X-ray backscatter imaging system. This advantageously provides an EOD operator with a hand-held, backscatter imaging detector that has an ability to reconstruct the internal construction of a suspicious object under interrogation. Furthermore, the CAI apparatus preferably provides the EOD operator with information on material compositions of the object under interrogation to aid in distinguishing dangerous substances. Preferably, the CAI apparatus is in the form of a hand-held detector; however, it is optionally for being disposed on a small robotic platform. Preferably, the X-ray backscatter imaging detector also provides sufficient speed, contrast and spatial resolution for use in detection of APLs.

Unfortunately, the photoelectric effect attenuates the backscatter flux of photons and is not useful in IED detection. That said, it is potentially useful in conjunction with the CAI for providing information for use in a 3D reconstruction of the target object. Additionally, this process is sensitive to the average Z of the material in the target object and is optionally utilized to provide for material identification capability in a final system.

Advantageously, the CAI apparatus provides a valuable milestone in the development of X-ray backscatter imaging for use in APL detection, and also successfully addresses the IED problem, which has a significant value to military and police forces.

Numerous other embodiments may be envisaged without departing from the spirit or scope of the invention.

What is claimed is:

1. An apparatus for illuminating a target area comprising:
an isotopic radiation source for emitting radiation having a wavelength within a predetermined portion of the electromagnetic spectrum for illuminating the target area;
a detector array having a plurality of detector elements that are responsive to the wavelength of the radiation, each of the detectors for providing a current in response to an intensity of the radiation incident thereon, the detector array only for receiving reflected radiation at the wavelength; and,
a pixel coded mask (PCM) having a plurality of apertures transmissive to at least the wavelength of radiation for emission from the isotopic radiation source and in a predetermined spatial orientation forming the pixel coding therein, each aperture for passing backscatter radiation reflected from the target area at the wavelength, the mask for blocking propagation therethrough of radiation reflected from the target area at the wavelength other than through the apertures thereof, the PCM apertures spatially arranged with respect to the detector array for forming a plurality of pixel shadows on the detector array.

2. An apparatus according to claim 1, comprising a processor for receiving the current from each detector element and for convolving data representative of this current with data relating to the PCM aperture spatial arrangement to derive image data of the target area.

3. An apparatus according to claim 2, comprising a display unit for receiving the image data of the target area and for displaying this image data in a human intelligible form.

4. An apparatus according to claim 1, comprising a housing, the housing having a first aperture and a second aperture, the first aperture for receiving of the detector array and the second aperture for receiving of the PCM, where the housing is opaque to the wavelength of the radiation and permits mostly backscatter radiation propagated through the PCM to impact the detector array.

5. An apparatus according to claim 1, wherein the PCM comprises a receptacle for receiving of the radiation source and for directing the emitted radiation therefrom in a direction other than towards the detector array.

6. An apparatus according to claim 5, wherein the receptacle comprises a feature for providing a predetermined half angle for the radiation emitted therefrom.

7. An apparatus according to claim 6, wherein the predetermined half angle is between 0 degrees and 60 degrees.

8. An apparatus according to claim 5, wherein the receptacle is disposed at a geometric center of the PCM.

9. An apparatus according to claim 1, wherein the PCM comprises a material that attenuates the radiation reflected from the target area.

10. An apparatus according to claim 1, wherein the radiation source is an X-ray radiation source.

11. An apparatus according to claim 1, wherein the PCM is computer generated from data derived from a MURA.

12. An apparatus according to claim 11, wherein the PCM is comprised of a mosaic of MURA masks.

13. An apparatus according to claim 1, wherein the energy of the isotopic radiation (Eγ) source is less than 1022 keV.

14. A method of illuminating a target area comprising the steps of:
providing a PCM having a mask response matrix;
providing a detector array comprising an array of detector elements;
providing an isotopic radiation source;
providing radiation from the isotopic radiation source for illuminating the target area with radiation;
receiving backscatter radiation backscattered from the target area;
propagating the backscatter radiation through apertures of the PCM, the apertures transmissive to at least a wavelength of the backscattered isotopic radiation;
forming a plurality of pixel shadows on the detector array;
generating current from each of the detector elements; and,
generating data representative of the current from each the detector elements.

15. A method according to claim 14, comprising the steps of:
storing this data in a detector response matrix;
deconvolving the mask response matrix with the detector response matrix to obtain image data; and,
providing the image data for visual representation thereof.

16. A method according to claim 14, comprising the steps of:
providing a first position of the PCM relative to the target area;
forming a first magnification of the target area on the detector array and casting a first mask shadow on the detector array;
providing a second position of the PCM relative to the target area;
forming a second magnification of the target area on the detector array and casting a second mask shadow on the detector array; and,
reconstructing a depth of the target area by evaluating first and second mask shadows and first and second magnifications.

17. A method according to claim 15, wherein an area of a pixel shadow formed on the detector array is dependent upon a proximity of the PCM to the target area.

18. A method according to claim 15, wherein data for forming pixels for the PCM is derived from a MURA.

19. A method according to claim 18, wherein the MURA is mosaiced to form data for the pixels of the PCM.

20. A method according to claim 19, wherein by using the MURA a depth of the target area is observable.

21. A method according to claim 14, where the target area comprises an improvised explosive device (IED).
